(19) United States
(12) Patent Application Publication
(10) Pub. No.: US 2004/0040239 A1
(43) Pub. Date: Mar. 4, 2004

(54) Prefabricated thin wall concrete panel

(76) Inventor: Paul Baillargeon, Beauce (CA)

Correspondence Address: OGILVY RENAULT, 1981 MCGILL COLLEGE AVENUE, SUITE 1600, MONTREAL, QC, H3A2Y3, CA

(21) Appl. No.: 10/230,230

(22) Filed: Aug. 29, 2002

(51) Int. Cl. E04C 1/00; B44F 7/00; B44F 9/00

(52) U.S. Cl. 52/309.9; 52/309.12; 52/309.17; 52/314; 52/315

(57) ABSTRACT

A prefabricated concrete wall panel is described which may have a bottom foundation section, when adapted to be mounted at least partly underground, and a top wall section. The wall panel has an outer concrete panel section and an inner concrete panel section spaced from one another by an insulating foam material adhered to an interior surface of the panel sections. The wall panel has opposed flat parallel side walls and top and bottom end walls. The outer concrete panel section has an exterior finished surface. The concrete wall panel also has connecting pins of predetermined equal length projecting from the bottom end wall to provide for support engagement in holes of predetermined depth formed in a top wall of a footing, a floor or a wall, and which provides automatic leveling and alignment of the panel. A method of fabricating a wall structure using the prefabricated wall panel is also disclosed.

### TECHNICAL FIELD

The present invention relates to a composite prefabricated concrete and insulating foam material panel, and including the method of fabricating a concrete wall utilizing such panels.

### BACKGROUND ART

Various prefabricated or precast concrete wall panels are known for fabricating building structures or walls attached to the structure. The majority of known prefabricated concrete wall panels either utilize these panels as the exterior cladding, with a conventional inner wall being built adjacent an inner surface of the panel and insulated with conventional material, such as wool insulation, or insulated concrete wall panels having insulating polystyrene panels glued thereto. Most of the known prefabricated or precast concrete wall panels are for erection on foundation walls or to be attached to a structure. The assembly of precast concrete wall panels known in the art most often requires metal connectors that are welded together in order to interconnect the panels to a foundation or a structure and to each other. This is a time-consuming and expensive method of construction. Also, most known prefabricated concrete wall panels are very heavy and cumbersome to transport. Accordingly, only a few panels are transported on flatbed trucks at a time to a construction site, and this also adds to the cost of a building structure.

There is a need to provide prefabricated concrete wall panels that are insulated, lightweight, easy to manipulate, can be installed quickly in alignment and leveled, that have a finished texture on at least an outer surface or on both the outer and inner surfaces of the panel and wherein the panel can provide its own foundation or be easy to interconnect to a footing.

### SUMMARY OF INVENTION

It is a feature of the present invention to provide a prefabricated concrete wall panel that provides the above needs.

Another feature of the present invention is to provide a prefabricated concrete wall panel that can be made with a plurality of exterior embossed finished surfaces and wherein the inner concrete wall panel may also have an interior finished surface and be provided with floor and roof connectors whereby to construct a building structure using a plurality of these panels.

Another feature of the present invention is to provide a prefabricated concrete wall panel and wherein an inner insulated foam material is adhered to the inside surfaces of opposed outer and inner concrete panel sections and adhered thereto by exposed fibers that are mixed with the concrete to form a composite concrete and insulating foam material bearing wall.

Another feature of the present invention is to provide a prefabricated concrete wall panel that is provided with connecting pins to support and interconnect the panel to a footing, a wall or a floor that is provided with aligned pin-locating holes having predetermined depths whereby to automatically level and align a plurality of panels together.

Another feature of the present invention is to provide a prefabricated concrete wall panel, with the outer or inner or both surfaces of the top section of the concrete panel having an embossed pattern provided with discrete construction material pieces and which may be casted with concrete of a different color to simulate real construction material pieces.

Another feature of the present invention is to provide a method of fabricating a wall structure utilizing prefabricated wall panels constructed in accordance with the present invention.

According to the above features, from a broad aspect, the present invention provides a prefabricated concrete wall panel comprising a bottom foundation section, adapted to be mounted at least partly underground, and a top wall section. The wall panel has an outer concrete panel section and an inner concrete panel section spaced from one another by an insulating foam material adhered to an interior surface of the panel sections. The wall panel has opposed flat parallel side walls and top and bottom end walls. The outer concrete panel section has an exterior finished surface.

According to a further broad aspect of the present invention, the prefabricated concrete wall panel is provided with footing-connecting pins projecting an equal predetermined length from the bottom end wall thereof and adapted to be received in pin-locating holes formed in a top surface of a footing or foundation and wherein said pin-locating holes are of predetermined depth to provide for auto-leveling and alignment of a plurality of the prefabricated concrete wall panels disposed side by side.

According to a still further broad aspect of the present invention, there is provided a prefabricated concrete wall panel comprising a bottom foundation section adapted to be mounted at least partly underground, and a top wall section projecting above ground. The top wall section has an exterior embossed patterned surface on at least one of an exterior or interior surface thereof. The wall panel has opposed flat parallel side walls and a top and bottom end wall. The bottom end wall has footing-connecting pins. The connecting pins project an equal predetermined length and are received on a top wall of a footing having pin-locating holes, which provides for automatic leveling and alignment of a plurality of prefabricated concrete wall panels disposed side by side.

According to a still further broad aspect of the present invention, there is provided a method of fabricating a wall structure utilizing prefabricated wall panels of the present invention. The method comprises providing a footing on a ground surface and drilling pin-locating holes having precise dimensions at predetermined locations along a top surface of the footing using a leveling instrument to determine the depth of said holes for installing a leveled panel. The said panel is positioned vertically on said footing with said footing-connecting pins projecting into complementary ones of said pin-locating holes and resting on a bottom end of the holes for self-leveling and alignment of a plurality of panels on said footing in side-by-side relationship. Once the panels and the pins are in place, the receiving holes are filled with epoxy which forms a “welding” between the side wall of the holes and the pins.

### BRIEF DESCRIPTION OF DRAWINGS

A preferred embodiment of the present invention will now be described with reference to the accompanying drawings in which:

FIG. 1 is a front elevation view illustrating the configuration of a prefabricated concrete wall panel constructed in accordance with the present invention;

FIG. 2 is a cross-section view along cross-section lines II-II of FIG. 1;

FIG. 3A is a front elevation view of a prefabricated concrete wall panel constructed in accordance with the present invention, and having an embossed patterned outer surface provided with discrete pieces projecting from one of the side walls of the panel in alignment with complementary piece cavity located adjacent the opposite side wall on the outer surface of the panel;

FIG. 3B are elevation views showing two discrete patterned templates having casted material pieces simulating a plurality of stones and integrated together in the outer surface of the top wall section of the outer concrete panel section of FIG. 3A, with thin bricks or stones to be glued in depressions to dissimulate the joint between panels;

FIG. 4 is an elevation view showing a concrete wall panel incorporating therein window openings having window frames and mounted in the wall panel;

FIG. 5 is a fragmented elevation view of a prefabricated rectangular concrete wall panel, which is longitudinal in shape, and which is adapted for mounting directly on the top surface of a foundation wall; and

FIG. 6 is a schematic view showing a jig assembly for drilling pin-locating holes at predetermined locations along a top surface of a foundation or a footing.

### DESCRIPTION OF PREFERRED EMBODIMENTS

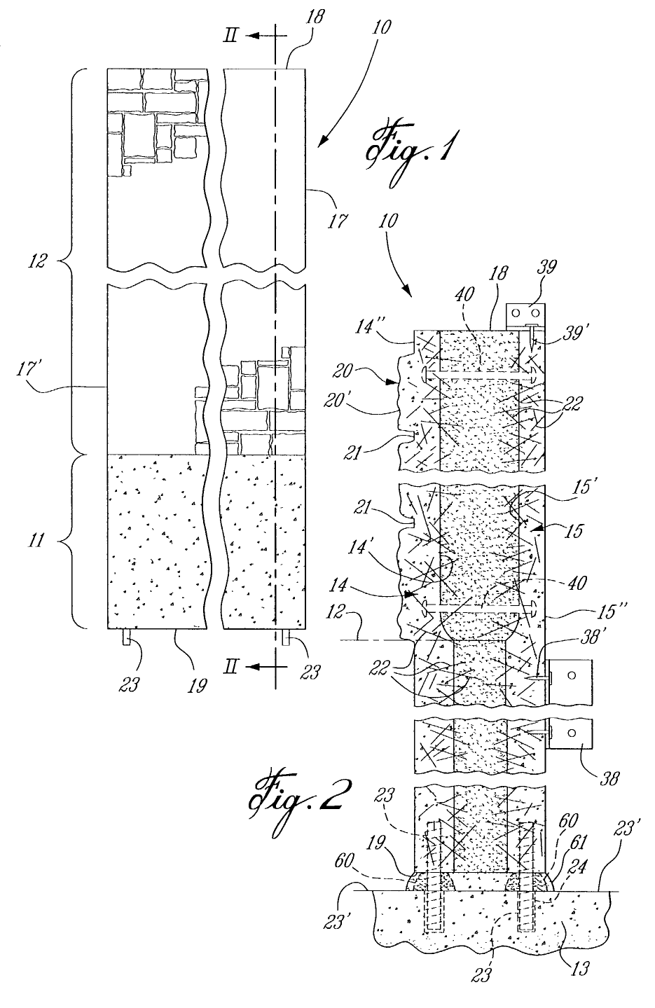

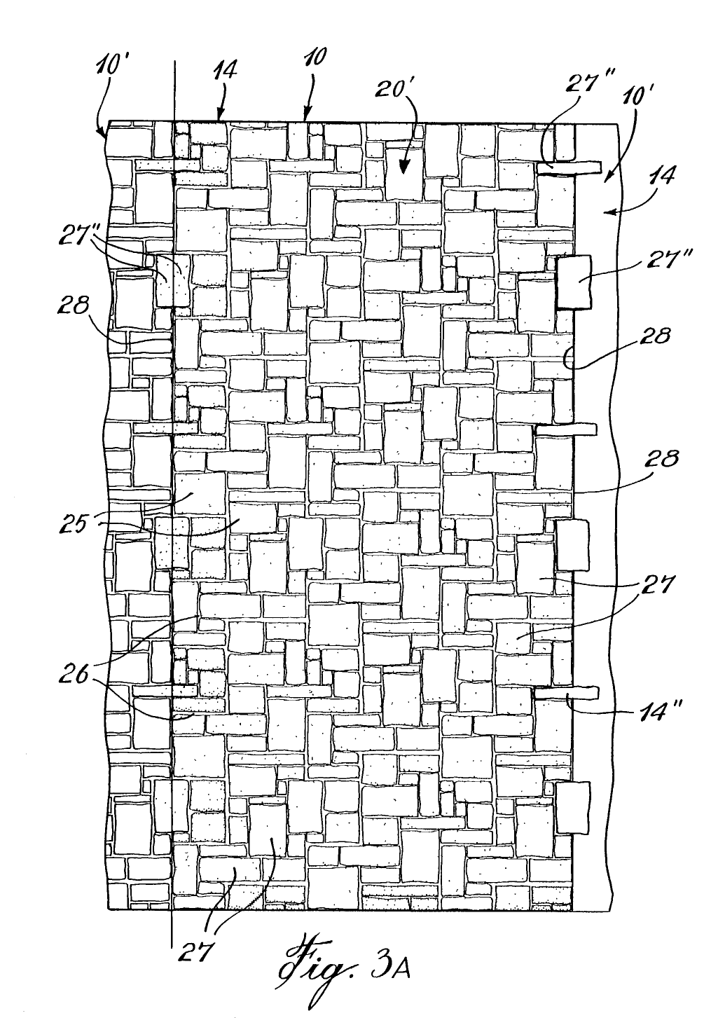

Referring now to the drawings, and more particularly to FIGS. 1 and 2, there is shown generally at 10 the prefabricated concrete wall panel of the present invention. The wall panel 10 comprises a bottom foundation section 11, which is adapted to be mounted at least partly under a ground surface 12, as shown in FIG. 2, and connected to a footing 13, as will be described later. The prefabricated concrete wall panel 10 also defines a top wall section 12, which is formed integral with the bottom foundation section, in the preferred embodiment herein described. However, in a further embodiment, as illustrated in FIG. 7, only a top wall section 12 is provided that can be secured directly on a top surface of a foundation wall by the pin connections.

As better seen from FIG. 2, the concrete wall panel 10 is a composite panel having an outer concrete panel section 14 and an inner concrete panel section 15. The panel sections are spaced from one another by an insulating foam material 16, which is adhered to an interior surface 14′ and 15′ of the concrete panel sections 14 and 15, respectively. As also herein shown, the foam material 16 has a greater thickness in the top wall section 12 than in the foundation section 11, although this is not essential as the insulating foam material 16 can be of a constant width throughout.

Furthermore, and as illustrated in FIGS. 1 and 2, the prefabricated concrete wall is of substantially rectangular configuration and defines opposed flat parallel side walls 17 and 17′, and opposed parallel top and bottom end walls 18 and 19, respectively. The outer concrete panel section 14 has an exterior embossed patterned surface 20 formed integral therewith to simulate an assembly of exterior finished construction material, such as stone, as herein shown, brick or wood boards, etc. The spacing between the embossed pattern pieces 20′ defines a joint 21, which simulates a mortar joint.

The insulating foam material 16 is a polyurethane foam or other suitable insulating foam capable of being applied in a mold containing the panel sections and expanding therebetween and adhering to the inner surfaces 14′ and 15′ of the outer and inner concrete panel sections. However, to ensure better bonding of the foam to these panels, the concrete that is utilized to form these panel sections has fibers 22 mixed with the concrete. These fibers replace the reinforcing steel. These fibers may be applied to the concrete at the mixing stage to make sure it is uniformly distributed once the concrete is poured. The fibers can project from the inner surfaces 14′ and 15′, respectively. These fibers then bind with the foam material when it is injected between the panels to provide a stronger connection between the foam and the panel sections 14 and 15. The adhesion between the foam, herein polyurethane, and the concrete is very strong, but can be made stronger by using glue on the inner surfaces of the panel sections 14 and 15.

As herein shown, the concrete wall panel 10 is further provided with footing-connecting pins 23 that project from the bottom end wall 19 at a predetermined equal distance therefrom. As shown in FIG. 2, the footings 13 on which these panels are supported are also provided with pin-locating holes 24, which are predrilled using a jig assembly, as will be described later with reference to FIG. 8. The pin-locating holes 24 may have different depths, depending on the level of the top surface 23′ of the footing 23.

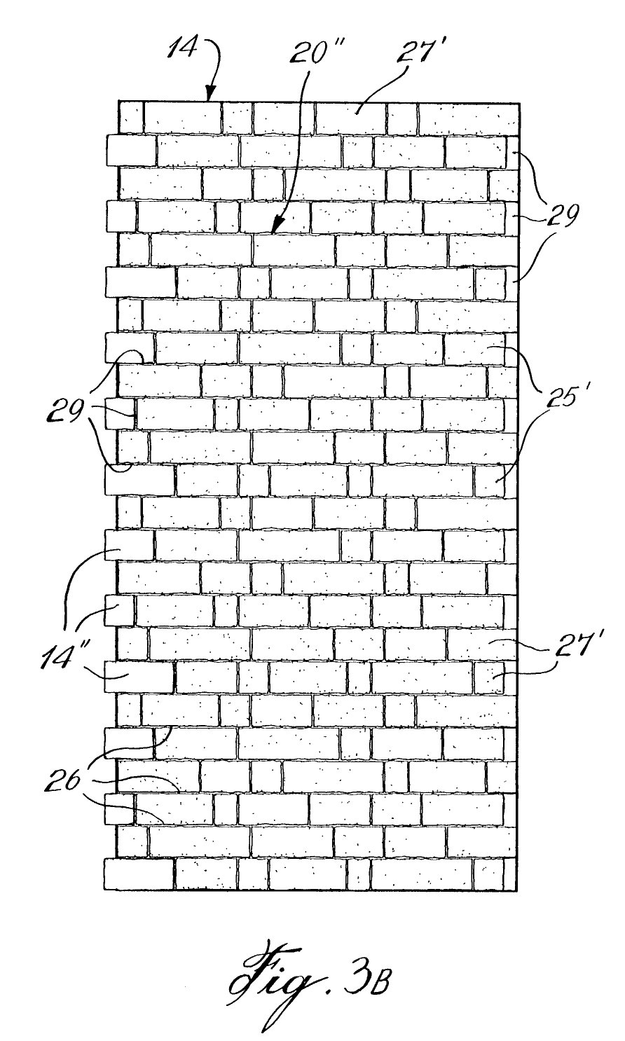

Referring now to FIGS. 3A and 3B, there is shown an embossed stone and brick pattern 20′ and 20″ respectively, on the outer surface 14″ of the outer concrete panel section 14, whereby to simulate a stone wall. The stones and bricks 25 and 25′, are formed by two different templates. These pattern templates produce mortar joints 26 which delineate each of the discrete construction material pieces 27 and 27′. Concrete is poured over these templates, which are located against a bottom wall of a mold, not shown herein but obvious to a person skilled in the art.

As shown in FIG. 3A and 3B, some of the discrete material pieces 27 are missing along the opposed side edges 28 of the panel sections 14 and replaced by cavities 29, or cavity portions, to receive thin material pieces 27″ adhesively secured in the aligned cavity portions 27″ of opposed wall panels, such as panels 10 and 10′ to bridge the abutting side edges of the panels. The material pieces 27″ provide a connection between the panels and camouflage the joints. It is also pointed out that these cavities 29 can also be formed in adjacent top and bottom end walls 18 and 19 when panels are laid one on top of another to also provide horizontal seam connections. When panels are to be laid one on top of another, the top wall 18 of the lower panel is provided with pin-locating holes of sufficient depth to receive the footing-connecting pin projecting from the bottom end wall of the uppermost panel. This provides quick and easy alignment.

FIG. 4 illustrates a still further embodiment of the prefabricated concrete wall panel 10″ and wherein the panel is provided with window and door openings 35 having different configurations. Also, the discrete material pieces in the embossed pattern can be of different sizes, whereby to simulate window ledges 36 and window crowns 37, or any other decorative brick or stone pattern. The window frames and sashes may also be pre-mounted. Although not illustrated, the discrete material pieces can simulate wood planks disposed horizontally or vertically. It is also pointed out that, in the casting of the outer concrete panel section 14, the templates disposed on the bottom surface of the mold can be filled with a colored concrete, thereby simulating certain material, such as red brick or grey brick, or colored planks, etc. After this concrete has set slightly, a second layer of concrete is poured binding to the first layer, delineating the discrete material pieces, so that when the panel section is pulled out of the mold the discrete pieces have one color and the joints 21 there-between will have the grey color of concrete simulating a motor joint.

As shown in FIG. 2, the outer surface 15″ of the inner concrete panel section 15 is provided with one or more floor joist connecting steel brackets 38, which project from the outer surface 15″ thereof and which are provided for interconnecting a floor structure to surrounding vertical walls of a building structure formed by a plurality of these prefabricated concrete wall panels 10. The inner concrete panel section 15 is further provided at a top end wall 18 thereof with a roof structure attachment bracket 39. These brackets are attached to the concrete panels when casted by fasteners 39′ and 38′, respectively. Of course, if these panels are to be laid one on top of the other, it is only the uppermost panel that will be provided with this roof structure attachment brackets 39.

As shown in FIG. 2, the panel 10 is further provided with transverse connecting rods 40 that are secured to and between the outer and inner concrete panels 14 and 15 and span the insulating foam material 16. These transverse connecting rods 40 are connected to the panel sections 14 and 15 prior to the injection of the insulating foam 16 between the panel sections. These transverse connecting rods 40 also prevent deformation of the panel sections during their fabrication stage and thereafter. During extreme temperatures, the exterior skin can curve if it is not retained.

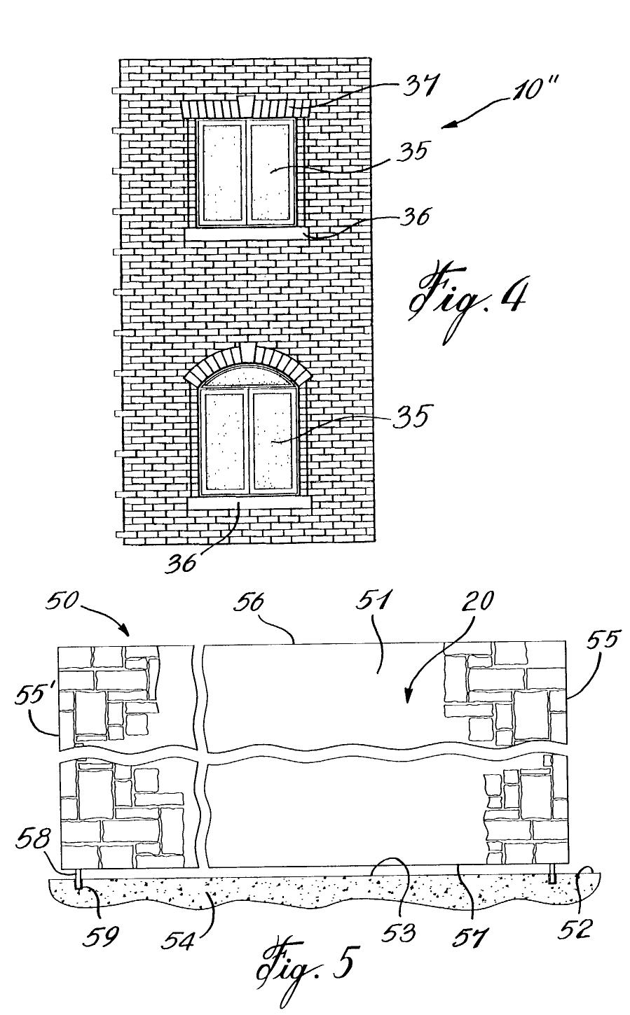

Referring now to FIG. 5, there is shown a prefabricated concrete wall panel 50 constructed in accordance with the present invention, but wherein the panel has a long span. As described above, the panels may have a multitude of dimensions. However, in the embodiment as shown in FIG. 5, the panel 50 only comprises a top wall section 51, which is intended to project above the ground surface 52 or the top wall 53 of a foundation 54. The top wall section 51 would also have an exterior embossed pattern surface 20, as described above, and this would be provided on at least the exterior or interior surface thereof or on both surfaces, depending on the intended use of this panel. of course, in warm climates, the inner concrete panel section 15 may not have a surface material affixed thereto, and merely the concrete would be exposed to act as a finished interior surface.

The panel 50 has opposed flat parallel side walls 55 and 55′ and opposed parallel top end wall 56 and bottom end wall 57. The bottom end wall is provided with footing-connecting pins 58 adjacent opposed ends thereof. As previously described, these connecting pins project a predetermined equal length and there are pairs of these pins adjacent opposed ends of the panels. These pins are disposed in pin-locating holes 59 provided in the top surface 53 of the foundation 54 and drilled with the jig assembly to provide auto-leveling and alignment. Of course, the foundation 54 may be merely a concrete footing if these panels are for mounting on soil that is not affected by frost, such as in warm climate areas. These wall panels 50 are mounted side by side and may be used to provide an elongated privacy wall. In the particular embodiment as described with respect to FIG. 5, the walls are solid concrete walls and do not have an insulating center core.

It is also preferred that the prefabricated concrete wall panels, as described above, when mounted on a footing or foundation wall, be further provided by a grout joint 60 (see FIG. 2), which is disposed in a lower space between the bottom end walls 19 of the concrete panels and the top surface 23′ of the footing 13. The grout can be applied on the bottom end wall of the panel about the pins 23 prior to positioning the panels on their foundation. A cement pad 61 is also disposed in the gap between the bottom end walls 19 of the panels 10 and the top wall 23′ of the footings 23 to seal this lower space.

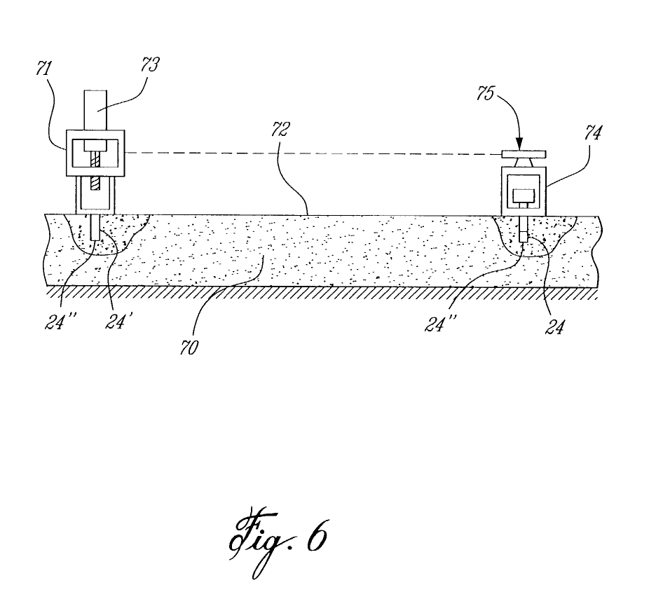

The method of fabricating a wall structure utilizing prefabricated wall panels 10 of the present invention comprises essentially the steps of providing a footing on a ground surface or providing a foundation 70, as illustrated in FIG. 6. Drilling jigs 71 are disposed at predetermined locations on the top surface 72 of the foundation wall 70, and a drill or drills 73 are placed in operation whereby to drill pairs of holes 24 of predetermined depth. A further jig 74 is then installed over the drilled holes 24 and, with the use of a laser device 75, ensures the proper location of the drilling jig 71 at a predetermined distance, on the footing, from the holes 24, whereby to drill a second pair of holes 24′ at a precise distance to match the distance between the sets of pins 58 projecting from the lower surface of the specific panels to be installed on the foundation wall. The laser instrument 75 is a leveling instrument and also determines the depth at which the second holes 24′ must be drilled whereby to ensure that the panels to be supported in these holes on their pins 23 are substantially perfectly leveled and also perfectly aligned longitudinally. Further holes are drilled adjacent each panel location to support adjacent panels. The adjacent panels are disposed on the foundation wall 70 with their connecting pins projecting into complementary ones of the pin-locating holes 24 and resting on the bottom ends 24″ of these holes. The depths of the holes vary depending on the level of the top surface of the footing or foundation whereby to support leveled panels. An epoxy sealant material 60, as previously described with reference to FIG. 2, is applied about the pins 23 against the bottom end wall 19 of the panel to seal the footing-connecting pins to the top surface of the footing to prevent humidity infiltration and rust. A cement grout 61 is disposed in any space between the top surface 72 of the footing 70 and the bottom end wall 19 of the panels to reinforce the connection therebetween and to seal that space. Another coat of sealant material, such as tar, may also be applied to the outside wall of the foundation section 11, particularly if the foundation section is buried in the ground. Although not shown, the vertical joints between the panels intended to be in the ground would also be sealed with a geotextile canvas or other sealant materials, not shown herein but obvious to a person skilled in the art.

Although not shown, electrical pipes or conduits are put in place within the wall whereby to be wired on site. If the inner surface is to form a finished surface, then nailing spots or convenient attachments can be put in place at specific locations to install curtains, blinds or to install anything on the wall inner surface, such as paintings, frames, etc.

It is within the ambit of the present invention to cover any obvious modifications of the preferred embodiment described herein, provided such modifications fall within the scope of the appended claims.

1. A prefabricated concrete wall panel comprising a bottom foundation section, adapted to be mounted at least partly underground, and a top wall section; said wall panel having a thin outer concrete panel section and a thin inner concrete panel section spaced from one another by an insulating foam material adhered to an interior surface of said panel sections, said wall panel having opposed flat thin parallel side walls and top and bottom end walls; said outer concrete panel section having an exterior finished surface.

2. A prefabricated concrete wall panel as claimed in claim 1, wherein said foam material has a thickness greater than the thickness of said outer or inner concrete panel sections.

3. A prefabricated concrete wall panel as claimed in claim 1, wherein said exterior finished surface is an embossed patterned surface simulating an exterior finished construction material.

4. A prefabricated concrete wall panel as claimed in claim 3, wherein said exterior finished construction material is one of stone, brick or wood boards, said stone and brick embossed pattern having simulated mortar joints.

5. A prefabricated concrete wall panel as claimed in claim 2, wherein said foam material is thicker in said top wall section than in said foundation section.

6. A prefabricated concrete wall panel as claimed in claim 5, wherein said foam material is a polyurethane foam.

7. A prefabricated concrete wall panel as claimed in claim 1, wherein said outer and inner concrete panel sections are formed of concrete having fibers mixed therewith, some of said fibers projecting from said interior surface of said panel sections to bind with said foam material to provide a positive connection between said foam and said panel sections.

8. A prefabricated concrete wall panel as claimed in claim 1, wherein said concrete wall panel bottom end wall is provided with footing-connecting pins, said connecting pins providing for leveling and alignment of said concrete wall panel on a footing having pin-locating holes therein.

9. A prefabricated concrete wall panel as claimed in claim 3, wherein said embossed patterned surface defines discrete construction material pieces, some of said pieces having a predetermined portion thereof projecting from one of said side walls in alignment with a complementary piece cavity located in said pattern surface adjacent said other of said side walls of an adjacent like concrete wall panel to form overlapping vertical seam connections between two adjacent like concrete wall panels.

10. A prefabricated concrete wall panel as claimed in claim 3, wherein said embossed patterned surface is provided with discrete construction material pieces, some of said pieces having a predetermined portion thereof being deficient on said finished outer surface to form discrete piece cavity portions adjacent said opposed flat parallel side walls, and discrete construction material pieces secured in aligned discrete cavity portions of adjacent side walls of adjacent concrete wall panels to overlap a vertical joint formed by said adjacent concrete wall panels and provide a connection between said adjacent panels.

11. A prefabricated concrete wall panel as claimed in claim 1, wherein an exterior surface of said inner concrete panel section is provided with one or more floor joist connecting brackets projecting therefrom for interconnecting a floor structure to surrounding vertical walls of a building structure formed by a plurality of said prefabricated concrete wall panels.

12. A prefabricated concrete wall panel as claimed in claim 11, wherein said inner concrete panel section is further provided with a roof structure attachment bracket secured to said top end wall thereof.

13. A prefabricated concrete wall panel as claimed in claim 1, wherein there is further provided transverse connecting rods secured to and between said outer and inner concrete panels and spanning said foam material in a top and bottom section of said wall panel to prevent deformation of said panel sections of said concrete wall panel.

14. A prefabricated concrete wall panel as claimed in claim 1, wherein one or more of said concrete wall panel is further provided with window or door openings.

15. A prefabricated concrete wall panel as claimed in claim 3, wherein said embossed patterned surface is formed by pattern templates disposed on a bottom surface of a mold, said embossed pattern being formed of a colored concrete to delineate said embossed pattern surface from said outer concrete panel, and joints formed by division walls of said templates delineating said discrete elements of said embossed pattern surface, said joints exposing said concrete material of said outer concrete panel section whereby to simulate grouted joints.

16. A prefabricated concrete wall panel comprising a wall section projecting above ground for mounting on a foundation, said top wall section having at least a portion of an exterior surface thereof provided as an embossed patterned surface on at least one of an exterior or interior surface thereof, said wall panel having opposed flat parallel side walls and top and bottom end walls, said bottom end wall having connecting pins projecting therefrom, said connecting pins being of equal predetermined length and adapted to be received in pin-locating holes drilled in a top surface of a footing to provide automatic leveling and alignment of a plurality of said prefabricated concrete wall panels in side-by-side relationship.

17. A prefabricated concrete wall panel as claimed in claim 16, wherein said plurality of wall panels are connected to said footing by said connecting pins to form an elongated privacy wall.

18. A prefabricated concrete wall panel as claimed in claim 17, wherein there is further provided an epoxy sealing joint between said bottom end walls of said concrete panels and said top surface of said footing about said connecting pins, and a cement pad sealing a space between said bottom end walls and said top surface.

19. A prefabricated concrete wall panel as claimed in claim 8, wherein there is further provided an epoxy sealing joint between said bottom end walls of said concrete panels and said top surface of said footing about said connecting pins, and a cement pad sealing a space between said bottom end walls and said top surface.

20. A method of fabricating a wall structure utilizing prefabricated wall panels in accordance with claim 7 or 15, said method comprising the steps of:
(i) providing a footing or foundation in a ground surface,
(ii) drilling pin-locating holes having precise dimensions at predetermined locations along a top surface of said footing or foundation using a leveling and aligning instrument to determine the depth and location of said holes for installing a leveled panel, and
(iii) positioning each said panel vertically on said footing or foundation with said footing-connecting pins projecting into complementary ones of said pin-locating holes and resting on a bottom end of said holes for self-leveling and alignment of said panel.

21. A method as claimed in claim 20, wherein there are two of said footing-connecting pins projecting from opposed end portions of said panel bottom end wall, said step ii) comprising drilling two pairs of said pin-locating holes in spaced-apart relationship using a jig assembly for precise location and leveling adjustment thereof using a laser instrument whereby the depth of said pin-locating holes is precise for support engagement of ends of complementary footing-connecting pins of a panel.

22. A method as claimed in claim 20, wherein there is further provided the step (iv) of inserting a cement grout in a space between said top surface of said footing or foundation and said bottom end wall of said panel to reinforce the connection therebetween.

23. A method as claimed in claim 20, wherein there is further provided the step of disposing a sealant material in said pin-locating holes to seal said footing-connecting pins to said top surface of said footing about said pin-locating holes.
